(19) United States
(12) Patent Application Publication
(10) Pub. No.: US 2015/0330393 A1
(43) Pub. Date: Nov. 19, 2015

(54) METHOD OF EVALUATING AN OPERATING STATE OF A FLOW MACHINE AS WELL AS FLOW MACHINE

(71) Applicant: Sulzer Management AG, Winterthur (CH)

(72) Inventor: Stefan BERTEN, Winterthur (CH)

(21) Appl. No.: 14/650,039

(22) PCT Filed: Nov. 26, 2013
(86) PCT No.: PCT/EP2013/074665

§ 371 Date: Jun. 5, 2015

(30) Foreign Application Priority Data
Dec. 19, 2012 (EP) 12198018.9

(51) Int. Cl. F04D 15/00; G01L 5/16; F04D 1/06

(52) U.S. Cl. CPC F04D 15/0088; F04D 1/06; G01L 5/16

(57) ABSTRACT

A method of evaluating an operating state of a flow machine includes measuring, in the operating state of the flow machine, a first force component of a bearing force acting on a rotor axle along a first direction using a first force sensor, the first direction lying perpendicularly to the axial direction, measuring a second force component of the bearing force in a second direction using a second force sensor, the second direction lying perpendicularly to the axial direction and being simultaneously perpendicular to the first direction, a resulting force being formed from the first force component and the second force component, preparing a frequency spectrum of the resulting force using a frequency analysis, comparing the frequency spectrum with a reference spectrum, and evaluating an operating state at a predefined operating state of the flow machine.

### CROSS-REFERENCE TO RELATED APPLICATIONS

This application is a U.S. National stage application of International Application No. PCT/EP2013/07665, filed Nov. 26, 2013, which claims priority to EP Patent Application 12198018.9, filed Dec. 19, 2012, the contents of each of which are hereby incorporated herein by reference.

### BACKGROUND

1. Field of the Invention

The invention relates to a method of evaluating an operating state of a flow machine, in particular of a pump, as well as to a flow machine, in particular to a pump.

2. Background Information

The partial load operation of turbines or pumps, in particular, but not only of centrifugal pumps, is usually associated with increased levels of vibrations which negatively impair the operating behavior of these machines. The causes of this increase in the level of vibrations is in this respect frequently found in hydrodynamic processes which are specifically determined inter alia by the partial load operation.

The interaction between rotating and stationary flow fields names causes spatially and temporally distributed pressure fields which can excite mechanical natural frequencies of the impeller, but also those of the stationary machine components. These vibrations, if they are not sufficiently damped, can in the worst case result in the destruction of the impeller, which is also called a blade wheel or rotor, or in damage to or destruction of other machine parts of the flow machine.

Since practically all modem high-performance machines of the aforesaid type, in particular high-performance pumps, are operated at variable speeds, operating points at which the pressure pulsations excite a natural frequency of the impeller due to rotor-stator interaction (RSI) are almost unavoidable in practice.

In this respect, further phenomena are in particular superimposed on the phenomena of the RSI pressure pulsations in partial load operation. Local breakaways influence the structure of the flow in the hydraulic channels of the pump and can cause further deformations and vibrations at other frequencies.

It has been found in this respect that while only the RSI pressure pulsations contribute to the deformations of the impeller in addition to the unavoidable mechanical imbalances in the design volume flow, that is in operating ranges for which the pump is designed in regular operation, both stationary and rotating instabilities can occur under partial load.

Stationary breakaways in the stator which manifest as a non-rotating zone of high pressure followed by a pressure drop on the suction surface of the guide vane following in the direction of rotation cause additional pressure pulsations which can manifest in the impeller as pressure pulsations, in particular at the rotational frequency of the impeller and their harmonic oscillation components.

### SUMMARY

It is possible at specific volume flows that this zone of high pressure starts to rotate more or less slowly, that is breaks away, i.e. a breakaway zone forms and thus no longer remains spatially stationary. It has been found that this breakaway zone exerts a substantial influence on the mechanical load, for example a pump stage. In this respect, it has further been found that the moving or rotating breakaway zone may even be responsible for the greatest deformation of the impeller, in particular the cover disk of the impeller, which can be larger by a multiple than the deformations due to the rotor-stator interaction. The local pressure increase due to the breakaway in this respect generates a radial force which substantially circulates at the angular speed of the breakaway in the case of the rotating breakaway.

This phenomenon can in principle be demonstrated with the aid of the method of the radial and/or axial shaft vibration measurement. It could in this respect be shown that the wave center of the rotor shaft is determined directly by the position of the breakaway zone.

This can influence the rotor dynamics of the pump negatively, but can, on the other hand, be used to determine rotating instabilities since it is not always possible to identify rotating breakaways with the aid of external pressure sensors.

It is furthermore known that the wheel side onflow is negatively influenced by the presence of breakaways in the stator. The inflow of fluid with small peripheral speed namely substantially reduces the fluid rotation in the wheel side space and thus influences the pressure distribution in the wheel side space and stationary and transient, that is time variable, axial or radial forces resulting therefrom, which may also be present among others and which increase and decrease periodically in time. This can also be demonstrated with the aid of the axial and/or radial shaft vibration measurements.

These phenomena known from the prior art and problems relating thereto and their detection by methods of shaft vibration measurement have already been examined in detail in the specific case of pumps by the inventor and have been published in his dissertation “Hydrodynamics of High Specific Pumps for Off-Design Operating Conditions”, Thèse No 4642 (2010), École Polytechnique Fédérate de Lausanne.

It is very important in this respect in the operation of a flow machine to determine in good time when said flow machine is in an above-described unwanted operating state. As already mentioned, significant damage to or, in the worst case, destruction of the impeller or even of the whole machine can occur if such operating states are not recognized in good time and if corresponding counter-measures are not taken in good time which return the machine to non-damaging operating states again as quickly as possible.

Unfortunately, these operating states and the complicated coupled vibration processes associated therewith and described in detail above cannot easily be recognized. As already mentioned, in principle both the stationary and the transient, that is time-variable, pressure fluctuation and flow phenomena, in particular the stationary and rotating breakaways, can in principle be demonstrated indirectly with the aid of the method of shaft vibration measurement via the detection of the deflections of the rotor axle of the rotor or blade wheel of the machine. It has, however, been shown that the data acquired in this manner do not allow any universal conclusions on the pressure fluctuation and flow phenomena in the flow machine and thus do not allow any conclusion on its current operating state, that is an operating state evaluation based on such data is not possible.

The reason for this is that the size and the geometry of the machine and its detailed structure, whose power-wise or volume flow-wise configuration, the manner and the state of the fluid to be pumped or turbined and many other factors well known to the skilled person, significantly influence the vibration behavior of the rotor shaft, i.e. the time-dependent deflection behavior of the rotor shaft.

In other words, if a specific individual machine is observed in specific applications and under predefined operating conditions, no clear conclusion can be drawn on the basis of the time-dependent movement of the rotor shaft on the stationary and/or transient, that is time-variable, pressure fluctuation and flow phenomena which actually take place in the machine, in particular not on the damaging stationary and rotating breakaways.

This is only possible if very detailed calibration measurements are carried out beforehand at the individual machine, and indeed while taking account of the very specific application in which the machine is later intended to be operated, that is e.g. in dependence on the type, consistency or viscosity of the fluid to be pumped or turbined, on the holder in which the pump is fastened as a whole, on the strength and manner of the drive, on an operating temperature of the fluid to be pumped and on many further relevant parameters. In mathematical terms: useful conclusions can only be drawn on the stationary and/or transient, that is time-variable, pressure fluctuation and flow phenomena actually occurring from the time-dependent deflections of the rotor shaft from a position of rest using the method of the axial and/or radial shaft vibration measurement, that is from the time-dependent measurement of the position of the rotor axle of the impeller, when a very complex “transfer function” of the machine is known with a detailed taking into account of the specific operating conditions, which establishes a connection between the pressure fluctuation and flow phenomena, on the one hand, and the time-variable axial deflections of the rotor axle.

This is naturally a method which is less suitable for practice in many cases since the mentioned very complex calibration measurements have to be carried out for every individual machine and additionally while taking account of all imaginable operating parameters, etc. in order subsequently to be able to draw the correct conclusions from the measurement of the radial and/or axial deflection movements of the rotor shall.

This procedure is, however, not only very complex and thus expensive, but also often not able to be carried out reliably in practice. As already mentioned, the kind of the fluid to be processed by the machine can also play a role, for example. Its properties are, however, not exactly known in advance in many cases or can vary in an unforeseeable manner in the course of the operation of the flow machine. If e.g. a substance such as crude oil is to be pumped, the consistency of the crude oil can vary over time in a completely unforeseeable manner. The charge with gas, sand or water, or the chemical composition of the crude oil, etc. can thus vary over time, for example, which can have significant effects on e.g. the viscosity of the crude oil to be pumped so that the calibrations made, that is ultimately the transfer function used, is no longer correct and thus the incorrect conclusions are drawn from the measured deflections of the rotor shaft. The temperature of the fluid, the environmental temperature the pump is exposed to or other parameters known per se to the skilled person can also vary in an unforeseeable manner. In such cases, on the use of the known method of axial and/or radial shaft vibration measurement, damaging operating states might not be recognized, which can result in damage to or even destruction of the machine.

It is therefore the object of the invention to propose a new method of detecting damaging operating states of a flow machine, in particular of a pump, with which the stationary and/or transient, that is time-variable, pressure fluctuation and flow phenomena actually occurring in the operating state can be reliably detected and the problems known from the prior art can be avoided.

The subject matters of the invention satisfying this object are characterized by the features of the independent claims.

The dependent claims relate to particularly advantageous embodiments of the invention.

The invention thus relates to a method of evaluating an operating state of a flow machine which flow machine includes an impeller arranged at a rotor axle and the rotor axle with the impeller is supported in a shaft bearing rotatable about an axial direction in a machine housing of the flow machine. In accordance with the invention, a first force component of a bearing force acting on the rotor axle is measured in the operating state of the flow machine using a first force sensor along a first direction, which first direction lies perpendicular to the axial direction. A second force component of the bearing force is measured using a second force sensor in a second direction, which second direction likewise lies perpendicular to the axial direction and preferably, but not necessarily, perpendicular to the first direction. Then a resulting force is formed from the first force component and the second force component, a frequency spectrum of the resulting force is prepared using a frequency analysis, the frequency spectrum is compared with a reference spectrum and finally, an operating state evaluation is carried out from this in a predefined operating state of the flow machine. The invention furthermore relates to a flow machine for carrying out the method in accordance with the invention.

It is thus material to the invention that two force components which act on the rotor axle in the operating state are measured preferably, but not necessarily, simultaneously using at least two force sensors in at least two different directions.

The decisive difference from the prior art is thus that it is not the deflections of the shaft which are measured, but rather directly the forces which act on the shaft.

It is a central realization of the invention that, since the forces acting on the shaft and not the deflections of the shaft are measured and evaluated, the initially described problems which occur in the shaft vibration measurement known from the prior art can practically be completely avoided.

The data acquired using the force measurements in accordance with the invention namely allow conclusions on the pressure fluctuation and flow phenomena in the flow machine and thus on its current operating state which have a much more universal character than the data obtained from the shaft vibration measurements.

Specific parameters of the flow machine, such as its geometry, power, etc., must naturally likewise be taken into account for a reliable evaluation of the measured data in accordance with the invention. These are, however, substantially only machine-specific data in this respect which are intended, on the one hand, to enter into a suitable calibration so that then the operating state of the flow machine is monitored, and which can be extremely reliably determined from the measured data of the forces acting on the rotor axle acquired in accordance with the invention under very different conditions, also under conditions initially not known or not foreseeable.

In other words, if a specific individual machine is looked at, an unambiguous conclusion can now be obtained due to the determination of the time-dependent forces acting on the rotor shaft by the use of the method in accordance with the invention on the stationary and/or transient, that is time-variable, pressure fluctuation and flow phenomena actually occurring, in particular on the damaging stationary and rotating breakaways without further parameters of the specific use such as the type or viscosity of the flowing fluid or of the fluid to be pumped, the environmental or machine temperature or other accompanying parameters substantially having to be taken into account.

A further major recognition of the invention is that the extremely complex processes which accompany stationary or transient breakaways can be recognized much more reliably and simply if the force components in different directions are not evaluated individually, but rather if a suitable averaging is first carried out in the form of a mathematical standard and thus the vectorial amount of the forces is specifically evaluated, for example. It has surprisingly been found that the breakaway phenomena in a flow machine can thus be detected much more reliably for practical applications than if the individual force components are separately observed.

In particular when a plurality of cells of breakaways occur simultaneously at different sites in the pump or even simultaneously with rotating breakaways, the breakaway phenomena can thus be detected much more reliably, simply, and thus also quickly using the method in accordance with the invention so that, on the use of the method in accordance with the invention, it is also possible to react much earlier to developing breakaway phenomena and possibly corresponding counter-measures can be initiated as soon as their arising first becomes visible.

It is understood in this respect that in practice the force components are preferably measured either at specific intervals or continuously or quasi-continuously over a predefined time period so that changes in the operating state can be tracked particularly easily and in particular the occurrence of damaging stationary or transient breakaways can be recognized in time as close to real time as possible and corresponding counter-measures can be taken to return the flow machine back to an uncritical operating state, where possible without or at least largely without any breakaways.

In principle, in a method in accordance with the invention, a measurement of the first force component can be carried out at a predefined time interval from a measurement of the second force component, with in practice the measurement of the first force component particularly preferably being carried out simultaneously with the measurement of the second force component.

Subsequent to the measurement of the force components, the resulting force can be formed in the form of a mathematic standard from the first force component and the second force component, with in particular the square root of the square of the absolute value of the force vector being formed as the resulting force in accordance with

Fr=[Fx²+Fy²]

To be able reliably to interpret a measurement with a given operating state of the machine, a reference spectrum of the resulting force must first be prepared which represents a known reference state of the machine, preferably a state in which the machine runs under ideal conditions, that is where possible without breakaways. The reference spectrum of the resulting force is in this respect prepared using the frequency analysis in the reference operating state of the flow machine.

To evaluate the operating state of the flow machine in another operating state, a frequency spectrum of the resulting force is then prepared such as was determined for the other operating state by measurement of the first and second force components, wherein the frequency analysis is preferably carried out using a Fourier analysis method, in particular using a fast Fourier analysis method, to prepare the frequency spectrum for the other operating state and/or to prepare the reference spectrum.

In this respect, in practice, the frequency analysis for preparing the frequency spectrum of the resulting force of the other operating state is advantageously, but not necessarily, carried out using the same method as the frequency analysis for preparing the reference spectrum.

For the specific determination of the operating state evaluation of the flow machine in the other operating state, an intensity in the frequency spectrum at a predefinable comparison frequency can be compared with an intensity of the reference spectrum at the same predefinable comparison frequency. If the intensity at the comparison frequency in the frequency spectrum of the other operating state differs noticeably from the intensity at the same comparison frequency of the reference spectrum, this indicates an undesirable operating state of the flow machine. The interpretation of differences from the reference spectrum will be explained in even more detail later with reference to the drawing.

In this respect, a basic frequency can particularly advantageously be selected as a comparison frequency which corresponds to a rotational frequency of the impeller, is in particular equal to or equal to a multiple of the rotational frequency of the impeller to determine a temporally and/or spatially stationary breakaway.

In order, for example, to achieve a correction of the operating state of the flow machine, in a special embodiment, the determined operating state evaluation can be supplied to a control device with which the flow machine can be suitably controlled or regulated in dependence on the operating state evaluation so that the flow machine can again be brought into an undisturbed operating state.

In this respect, the flow machine can in practice be a turbine machine or a pump, in particular a one-stage or multistage vertical or horizontal pump, specifically a pump for pumping multiphase mixtures, in particular a high-performance pump for providing high pump performance values or any other flow machine known per se.

The invention moreover relates to a flow machine for carrying out a method in accordance with the invention, which flow machine includes an impeller arranged at a rotor axle wherein the rotor axle with the impeller is supported in a shaft bearing rotatable about an axial direction in a machine housing of the flow machine. In accordance with the invention, a first force sensor is provided at the rotor shaft such that a first force component of a bearing force acting on the rotor axle can be measured along a first direction, which first direction preferably lies perpendicular to the axial direction and a second force sensor is provided at the rotor shaft such that a second force component of the bearing force is measured in a second direction, which second direction can likewise preferably lie perpendicular to the axial direction and simultaneously perpendicular to the first direction, but can also lie obliquely, that is not perpendicular, to the first direction.

In this respect, in a flow machine in accordance with the invention, a respective plurality of force sensors, preferably a pair of two force sensors arranged opposite at the rotor axle, can naturally also be provided so that the force component can be measured simultaneously or alternatively from two opposite directions along the direction, with naturally also in each case a plurality of force sensors, preferably a pair of two force sensors arranged opposite a the rotor axle, being able to be provided so that the force component can be measured simultaneously or alternatively from two opposite directions along the direction.

In practice, in this respect, a control device, in particular a computer-controlled control apparatus, can advantageously be provided so that the flow machine can be controlled or regulated using the control device in dependence on the operating state evaluation so that the flow machine can be controlled automatically in an advantageous operating state or can be kept in such advantageous operating states while using the measured results from the method in accordance with the invention.

### BRIEF DESCRIPTION OF THE DRAWINGS

The invention will be explained in more detail in the following with reference to the drawing. There are shown in a schematic representation:

FIG. 1a is an embodiment of a flow machine in accordance with the invention;

FIG. 1b is a section along the line I-I in accordance with FIG. 1a;

FIG. 2a is a reference spectrum;

FIG. 2b is a frequency spectrum for a state with a breakaway; and

FIG. 2c is a frequency spectrum for a state with two breakaways.

### DETAILED DESCRIPTION OF EMBODIMENTS

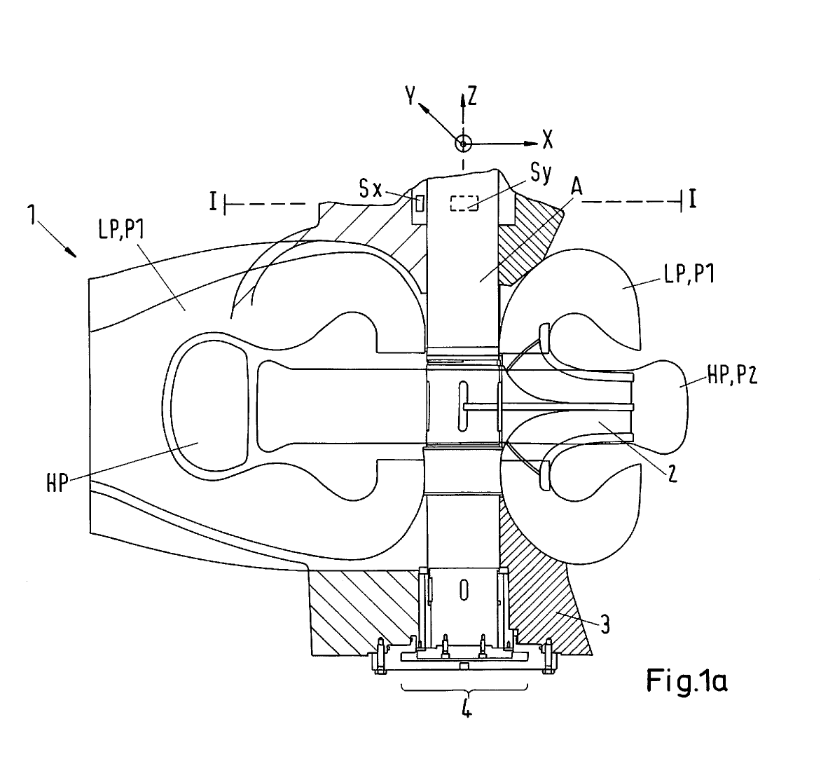

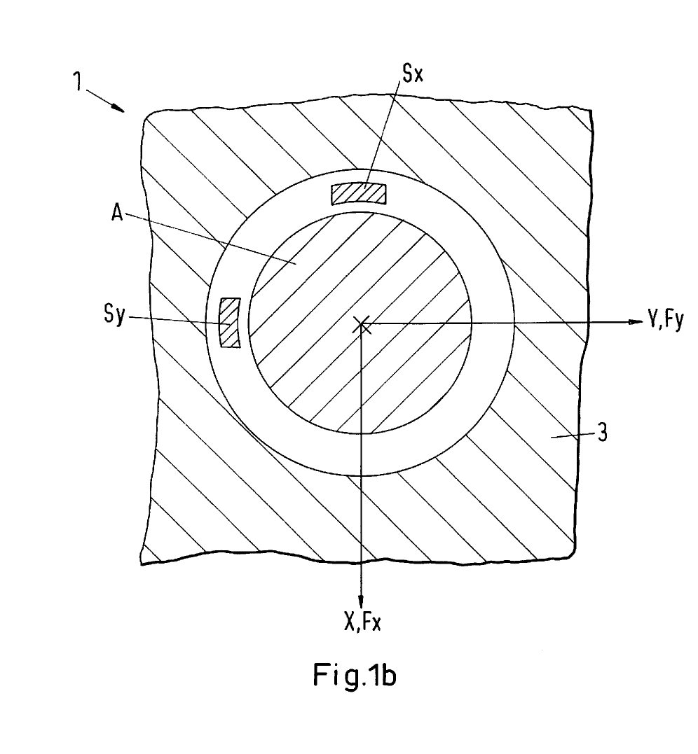

The specific embodiment of a flow machine in accordance with the invention is here in accordance with FIG. 1a and FIG. 1b respectively a pump which is designated in the following as a whole by the reference numeral 1 and which serves very generally and in particular in the specific embodiment of FIG. 1a for conveying a pump fluid possibly including an ingredient. The pump fluid is disposed at an inlet pressure PI at a low-pressure side LP of the pump 1 and is conveyed in the operating state by an impeller 2 supported in a shaft bearing 4 rotatable about a rotor axle A to a high-pressure side HP of the pump 1.

The rotor axle A with the impeller 2 is supported in the shaft bearing 4 rotatable about an axial direction Z in a machine housing 3 of the flow machine 1 configured as a pump. In accordance with the present invention, a first force sensor Sx is provided at the rotor shaft 2 such that a first force component Fx of a bearing force acting on the rotor axle A in the operating state can be measured along a first direction X, which first direction X lies perpendicular to the axial direction Z in the preferred embodiment in accordance with FIG. 1a and FIG. 1b respectively. In addition, a second force sensor Sy is provided at the rotor shaft 2 such that a second force component Fy of the bearing force is measured in a second direction Y, which second direction Y lies perpendicular to the axial direction Z and simultaneously preferably perpendicular to the first direction X in the preferred embodiment of FIGS. 1a and 1b respectively.

FIG. 1b, which shows a section along the line I-I in accordance with FIG. 1a, illustrates the arrangement of the force sensors Sx, Sy at the rotor shaft 2 somewhat more exactly. The force sensors Sx, Sy measure the corresponding force components which act on the rotor shaft in the operating state.

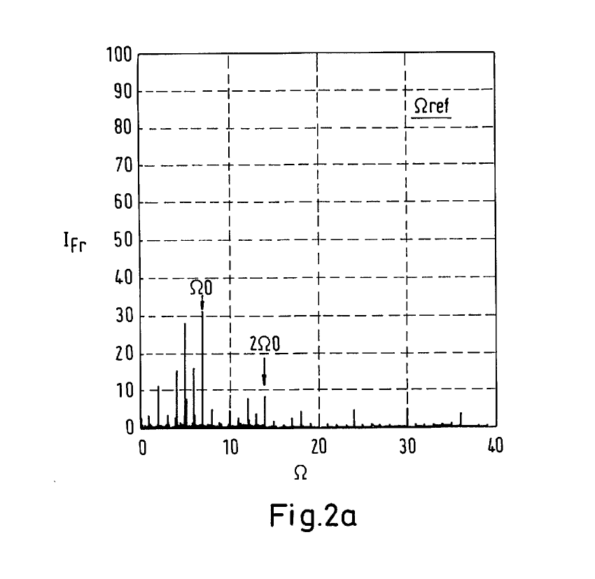

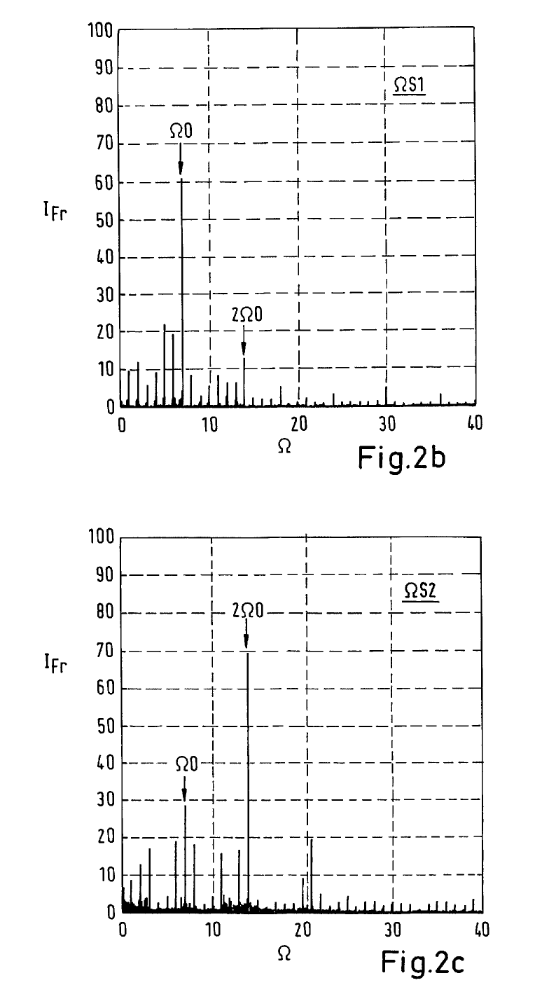

In the present embodiment, the resulting force Fr is then formed from the measured force components Fx, Fy in the form of a mathematical standard, here in accordance with Fr=[Fx²+Fy²]^{1/2} and a reference spectrum Ωref in accordance with FIG. 2a is prepared using a fast Fourier analysis, also known under the abbreviation FFT, said reference spectrum corresponding to an ideal operating state, that is to a reference operating state of the pump, in which substantially no breakaways are present. The reference operating state can e.g. be an operating state for which the pump was configured and in which it is operated under normal conditions, often in permanent operation.

If now the operating state of the pump changes, e.g. because the pump has to be operated in a first partial load range, it is possible that a breakaway forms within the pump housing.

This can, for example, be derived from the frequency spectrum ΩS1 because here a comparison of the intensity in the frequency spectrum ΩS1 at a predefined comparison frequency Ω with the intensity of the reference spectrum at the same frequency has the result that the intensity at the comparison frequency Ω, whose value was here selected as Ω0, which directly corresponds with the rotational frequency of the impeller 2, is considerably higher than in the reference spectrum.

If such a difference is found which indicates a breakaway, an alarm can e.g. be automatically triggered which indicates to an operator that he has to regulate the pump into a different operating state. Or, however, an automatic correction of the operating state of the pump can be carried out via the above-mentioned control device.

In this respect, the method in accordance with the invention in principle even allows the number of breakaways to be determined. FIG. 2c shows in this respect a frequency spectrum ΩS2 of a different operating state at which the intensity is considerably increased at twice the reference frequency 2Ω0 in comparison with the reference spectrum Ωref of FIG. 2a at the same frequency, whereas the intensity in the spectrum ΩS2 at the simple reference frequency Ω0 is only changed negligibly in comparison with the reference spectrum.

It is understood that all the embodiments of the invention described within the framework of this application are only to be understood as examples or by way of example and the invention in particular, but not only, includes all suitable combinations of the described embodiments as well as simple further developments of the invention which likewise are easily obvious to the skilled person without any further inventive step.

1. A method of evaluating an operating state of a flow machine, the flow machine including an impeller arranged at a rotor axle and the rotor axle with the impeller is supported in a shaft bearing rotatable about an axial direction in a machine housing of the flow machine, the method comprising:
measuring, in the operating state of the flow machine, a first force component of a bearing force acting on the rotor axle along a first direction using a first force sensor, the first direction lying perpendicularly to the axial direction;
measuring a second force component of the bearing force in a second direction using a second force sensor, the second direction lying perpendicularly to the axial direction and being simultaneously perpendicular to the first direction, a resulting force being formed from the first force component and the second force component;
preparing a frequency spectrum of the resulting force using a frequency analysis;
comparing the frequency spectrum with a reference spectrum; and
evaluating an operating state at a predefined operating state of the flow machine.

2. A method in accordance with claim 1, wherein
the measuring the first force component is carried out at a predefined time interval from the measuring the second force component.

3. A method in accordance with claim 1, wherein
the resulting force is formed from the first force component and the second force component in accordance with Fr=[Fx²+Fy²]^{1/2}.

4. A method in accordance with claim 1 wherein
the preparing the reference spectrum including preparing the reference spectrum from the resulting force using frequency analysis at a reference operating state of the flow machine.

5. A method in accordance with claim 4, wherein
the frequency analysis for preparing the frequency spectrum or for preparing the reference spectrum is carried out while using a Fourier analysis method.

6. A method in accordance with claim 4, wherein
the frequency analysis for preparing the frequency spectrum is carried out using the same method as the frequency analysis for preparing the reference spectrum.

7. A method in accordance with claim 1, further comprising
comparing an intensity in the frequency spectrum is compared at a predefinable comparison frequency with an intensity of the reference spectrum at the predefinable comparison frequency for preparing the operating state evaluation of the flow machine.

8. A method in accordance with claim 7, further comprising
selecting a base frequency as the comparison frequency which corresponds to a rotational frequency of the impeller, the base frequency being equal to or equal to a multiple of the rotational frequency of the impeller.

9. A method in accordance with claim 1, further comprising
determining a temporally or spatially stationary breakaway.

10. A method in accordance with claim 1, further comprising
supplying the operating state evaluation to a control device and controlling or regulating the flow machine in dependence on the operating state evaluation.

11. A method in accordance claim 1, wherein the flow machine is a turbine machine or a pump.

12. A flow machine for carrying out a method in accordance with claim 1, comprising:
the impeller arranged at the rotor axle, and the rotor axle with the impeller being arranged in the shaft bearing rotatable about the axial direction in the machine housing of the flow machine;
the first force sensor disposed at the rotor shaft and being configured to measure the first force component of the bearing force acting on the rotor axle along the first direction, the first direction lying perpendicular to the axial direction;
the second force sensor disposed at the rotor shaft and being configured to measure the second force component of the bearing force in the second direction, the second direction lying perpendicular to the axial direction and simultaneously perpendicular to the first direction.

13. A flow machine in accordance with claim 12, wherein
a plurality of force sensors arranged opposite the rotor axle is disposed so that the first force component is measured simultaneously or from two opposite directions along the first direction; or or so that the second force component is measured simultaneously or alternatively from two opposite directions along the first direction.

14. A flow machine in accordance with claim 12, further comprising
a control device disposed so that the flow machine is controlled or regulated by the control device in dependence on the operating state evaluation.

15. A flow machine in accordance with claim 12, wherein
the flow machine is a turbine machine or a pump.

16. A method in accordance with claim 1, wherein
the measuring the first force component is carried out simultaneously with the measuring the second force component.

17. A method in accordance with claim 4, wherein
the frequency analysis for preparing the frequency spectrum or for preparing the reference spectrum is carried out while using a fast Fourier analysis method.

18. A method in accordance with claim 1, wherein
the flow machine is a single-stage or multistage vertical or horizontal pump for pumping multiphase mixtures.

19. A method in accordance with claim 1, wherein
the flow machine is a high-performance pump for producing high pump performance rates.

20. A flow machine in accordance with claim 12, wherein
the flow machine is a single-stage or multistage vertical or horizontal pump for pumping multiphase mixtures.
